(19) United States
(12) Patent Application Publication
(10) Pub. No.: US 2012/0005808 A1
(43) Pub. Date: Jan. 12, 2012

(54) DIGITALLY PRINTED APPLIQUÉ AND METHOD OF MAKING SAME

(75) Inventors: Kenneth A. Shwartz, Mattapoisett, MA (US); Charles W. Lord, Mattapoisett, MA (US)

(73) Assignee: Ahead, Inc., New Bedford, MA (US)

(21) Appl. No.: 12/833,339

(22) Filed: Jul. 9, 2010

(51) Int. Cl. A42B 1/02; A42B 1/24; B32B 38/04; D05B 23/00; B32B 3/00; B32B 3/10

(52) U.S. Cl. 2/195.1; 428/195.1; 428/138; 428/137; 156/256; 156/272.8; 112/475.08

(57) ABSTRACT

An appliqué is provided that is attached to the outer surface of a product. The appliqué comprises a decorative piece including an upper surface with a design element digitally printed thereon and an opposite lower surface attached to the product.

### BACKGROUND

The present application relates generally to decorative items and, more particularly, to appliqués. Appliqués are decorations or designs that are applied on top of larger surfaces of apparel and other products.

### BRIEF SUMMARY OF EMBODIMENTS OF THE INVENTION

In accordance with one or more embodiments, a method is provided for producing decorative articles and attaching the decorative articles to products. The method includes the steps of: digitally printing a plurality of design elements on an upper surface of a sheet of material; cutting the sheet of material into a plurality of decorative pieces, each containing a design element on an upper surface thereof; and securely attaching each of the decorative pieces to one of a plurality of products.

In accordance with one or more further embodiments, a method is provided for producing decorative articles and attaching the decorative articles to products. The method includes the steps of: cutting a sheet of material into a plurality of pieces having predetermined shapes; securing each of the pieces in a holder; digitally printing a design element on an upper surface of each of the pieces; and securely attaching a lower surface of each of the pieces to one of a plurality of products.

A product in accordance with one or more embodiments includes a body having an outer surface; and an appliqué attached to the outer surface of the body. The appliqué comprises a decorative piece including an upper surface with a design element digitally printed thereon and an opposite lower surface attached to outer surface of the body.

One or more further embodiments are directed to a decorative article attachable to a product. The decorative article includes a substrate piece and a decorative piece overlaid on the substrate piece. The decorative piece includes an upper surface with a design element digitally printed thereon and an opposite lower surface attached to the substrate piece. The decorative piece and the substrate piece are shaped such that a peripheral portion of the substrate piece extends beyond the periphery of the decorative piece to define a border for the decorative article.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1A is an illustration of an exemplary product on which an appliqué in accordance with one or more embodiments has been applied.

FIGS. 1B and 1C are illustrations of exemplary appliqués in accordance with one or more embodiments.

FIGS. 2A-2G are illustrations of an exemplary process of producing and applying an appliqué in accordance with one or more embodiments.

FIG. 3 is an illustration of an exemplary appliqué having cutout portions in accordance with one or more further embodiments.

FIG. 4 is an illustration of an exemplary product on which an appliqué with a substrate layer has been heat fused on a product in accordance with one or more embodiments.

FIG. 5 is an illustration of an exemplary product on which an appliqué without a substrate layer has been heat fused on a product in accordance with one or more embodiments.

FIG. 6 is an illustration of an exemplary appliqué without a substrate layer that has been stitched on a product in accordance with one or more embodiments.

FIGS. 7A-7D are illustrations of an exemplary process of producing an appliqué that is cut before being printed in accordance with one or more embodiments.

FIG. 8 illustration of an exemplary visor having an appliqué fused on the bill portion thereof in accordance with one or more embodiments.

FIG. 9 is illustration of an example of an appliqué with a printed stitch design in accordance with one or more embodiments.

### DETAILED DESCRIPTION

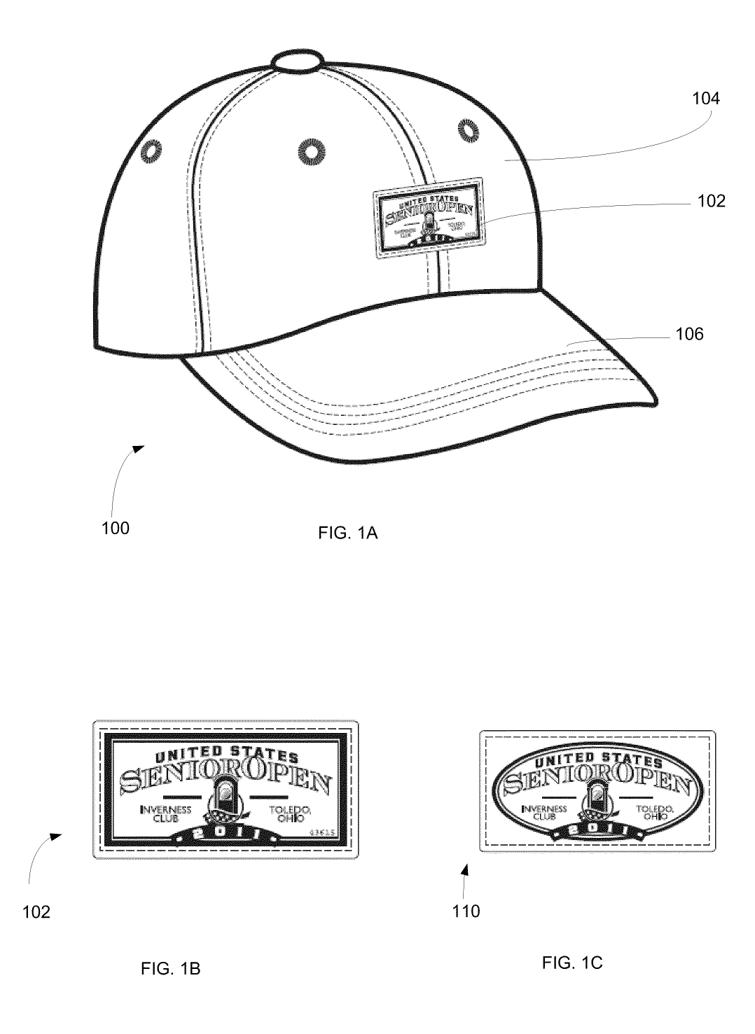

FIG. 1 illustrates an example of a product (in this case a baseball-type cap) 100, on which a digitally printed appliqué 102 in accordance with one or more embodiments has been applied. The cap 100 includes a crown portion 104 (defining an opening for receiving a portion of a wearer's head) and a hat bill or brim 106 attached to the crown portion 104. In this example, the appliqué 102 is affixed to the outer surface of the crown portion 104 near the bill 106, although it may be placed generally anywhere on the cap.

The cap 100 shown in FIG. 1 is just one example of a product on which a digitally printed appliqué 102 in accordance with one or more embodiments can be applied. For example, appliqués in accordance with various embodiments can be applied to a variety of other headwear, including, e.g., visors. Furthermore, the appliqués can be applied to a variety of other products including, but not limited to, apparel (e.g., shirts, pants, and jackets) and other products such as shoes, towels (e.g., golf towels), and carrying items, including backpacks. In general, the appliqués can be applied to virtually any product to provide a decorative or identifying effect.

FIG. 1B is an enlarged view of the appliqué 102 shown in FIG. 1A. FIG. 1C illustrates an example of another appliqué 110 in which the substrate layer does not conform to the shape of the printed design piece as will be discussed further below.

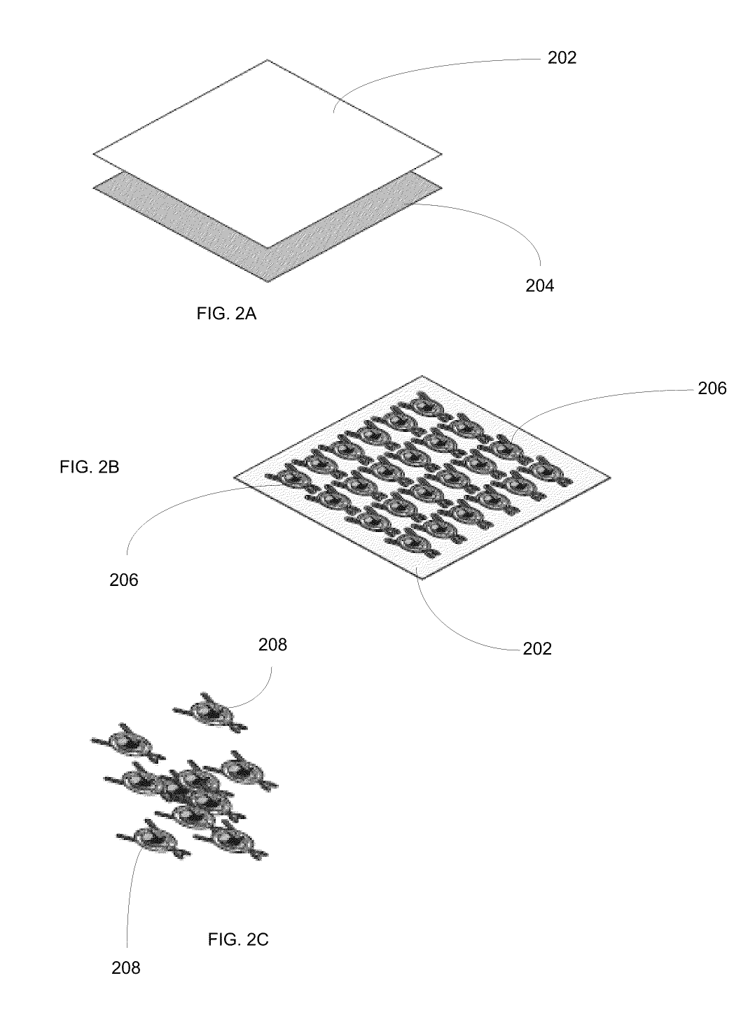

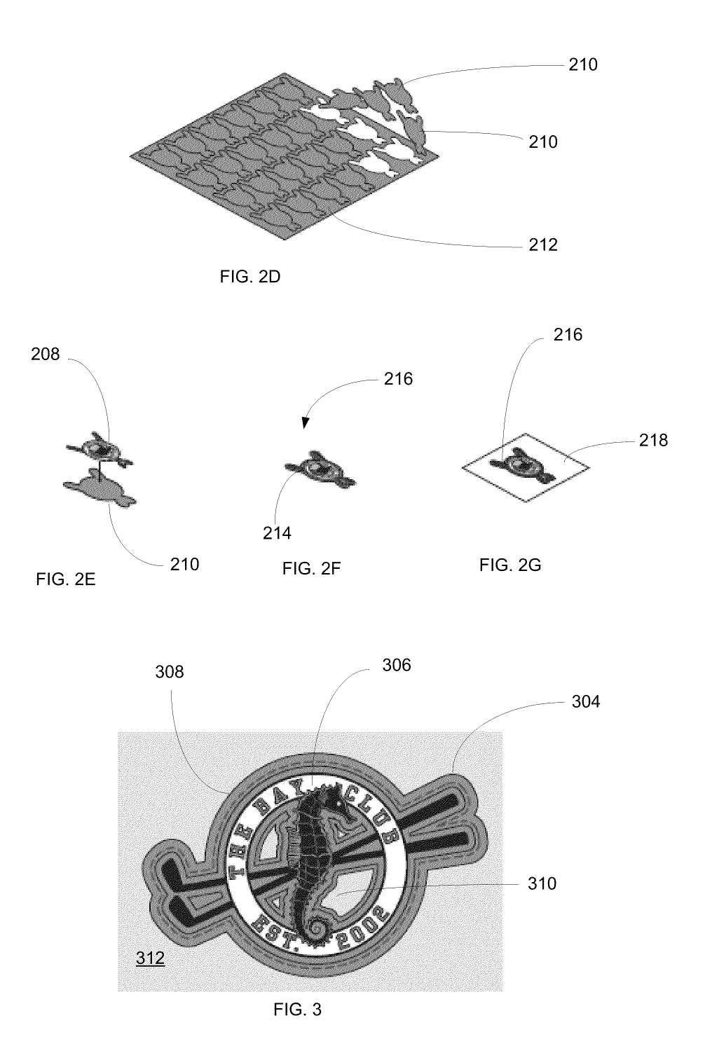

FIGS. 2A-2G illustrate, by way of example, a process of producing and applying an appliqué in accordance with one or more embodiments.

FIG. 2A illustrates a sheet of material 202, on the upper surface of which design elements or images can be digitally printed (as shown in FIG. 2B). As described below, the sheet of material 202 forms the upper layer of an appliqué.

The sheet of material 200 can comprise a variety of materials on which images can be digitally printed. In one or more embodiments, the sheet of material comprises a canvas material. The sheet of material 200 can also comprise many other materials on which images can be printed including, without limitation, woven material such as cotton twill, nylon, or faux-suede, as well as non-woven material such as felt, leather, suede, rubber, pellon, scrim-felt, molded or sheet rubber, molded or sheet plastic, or faux-leather.

An adhesive material 204 is provided on the lower surface of the sheet of material 202. In the illustrated embodiment, the adhesive material is a heat activated adhesive sheet (e.g., a “low temperature” heat fuseable material) that is lightly fused to the back of the sheet of material 202. A variety of other adhesive materials can also be used to provide a secure bond between the material 202 and a substrate. It should be noted that the adhesive backing 204 is optional; as discussed below, various other attachment techniques can be used including, e.g., using spray/liquid adhesives and sheet/tape adhesives, and stitching.

FIG. 2B illustrates the sheet of material 202 having multiple exemplary design elements 206 digitally printed on the top surface of the sheet 202. The design elements can be of varying sizes and shapes. The design elements are preferably printed using a digital garment or fabric printer, and the sheet can be heat cured to set the inks used in the printing process. Such printers can include inkjet printers that dispense garment colorfast inks. One example of a suitable printer is a model HM1-C printer available from SWF East of Tampa, Fla. Many other printers from various manufacturers can also be used. The design elements 206 can also be transferred to the sheet of material 202 using a heat “transfer” process wherein a design digitally printed on a transfer material is heat-pressed or ironed-onto the material 202. Examples of possible transfer materials include, but are not limited to, heat transfer papers available from New Milford Photo and PVC FlexWear™, PVC Neon FlexWear™, and PolyU FlexWear™ transfer materials available from T-ShirtSupplies.com.

The sheet of material 202 is cut around the perimeter of each of the design elements 206 to obtain multiple decorative pieces 208 as shown in FIG. 2C. The sheet of material 202 is preferably cut using a laser cutter, which allows intricate shapes to be quickly, easily, and accurately cut. However, it is also possible to use mechanical and other cutting processes including, e.g., die cutting using a sharp metal tool formed into the shape of the decorative pieces. Die cutting is particularly advantageous for reducing labor and time expenditure in producing large quantities of decorative pieces.

Substrate pieces 210, which are attached to the decorative pieces 208 as described in further detail below, are formed from a sheet of substrate material 212 as illustrated in FIG. 2D. Each of the substrate pieces 210 may have a shape similar to a decorative piece 208 that is slightly larger in size. Alternatively, substrate pieces 210 may have an entirely different shape than the printed pieces 208 as shown, e.g., in FIG. 1C. The sheet of substrate material 212 is preferably cut using a laser cutter, which allows intricate shapes to be quickly, easily, and accurately cut. Mechanical and other cutting processes can also be used including, e.g., die cutting as discussed above.

The sheet of substrate material 212 can comprise a variety of materials. In one or more embodiments, the substrate material comprises felt. The substrate material 212 can also comprise many other materials including, without limitation, woven material such as cotton twill, canvas, nylon, or faux-suede, as well as non-woven material such as leather, suede, rubber, pellon, scrim-felt, molded or sheet rubber, molded or sheet plastic, or faux-leather.

The sheet of substrate material 212 can have multiple plies to provide additional thickness, if desired.

As shown in FIG. 2E, each of the decorative pieces 208 is overlaid on a substrate piece 210. A heat press is used to securely fuse or bond the decorative piece 208 on the substrate piece 210, by activating the heat activated material 204 on the lower surface of each decorative piece 208. It should be understood that other techniques for bonding the decorative piece 208 on the substrate piece 210 can also be used including, e.g., use of spray/liquid adhesives and sheet/tape adhesives. In addition, the decorative piece 208 could be stitched to the substrate piece 210.

The resulting appliqué or decorative article 216 is shown in FIG. 2F.

As shown in FIG. 2F, because the substrate piece 210 has an outer shape that corresponds to and is slightly larger than the outer shape of the decorative piece 208, the peripheral portion of the substrate piece 210 extends beyond the periphery of the decorative piece 208 to define a visible border 214.

The appliqué 216 can then be applied to a cap or other product as shown in FIG. 2G. By way of example, the appliqué 216 is placed on a surface 218 (partially shown) of the product and then stitched to the product, preferably along the border 214. (The stitch, however, does not have to conform to the shape or border of the substrate.) For example, a triple run stitch can be used to a fix the appliqué 216 to the surface 218 of the product.

FIG. 3 illustrates an appliqué 302 in accordance with one or more further embodiments. The appliqué 302 includes a substrate piece 304 (in this example, a felt substrate) and a decorative piece 306 including a digitally printed image. The substrate piece 304 can correspond in shape to and be slightly larger than the decorative piece 306, thereby defining a border 308 around the appliqué. In this embodiment, both the substrate piece 304 and the decorative piece 306 include corresponding cutouts 310 that allow portions of the product on which the appliqué 302 is attached to show through to provide an aesthetically appealing effect.

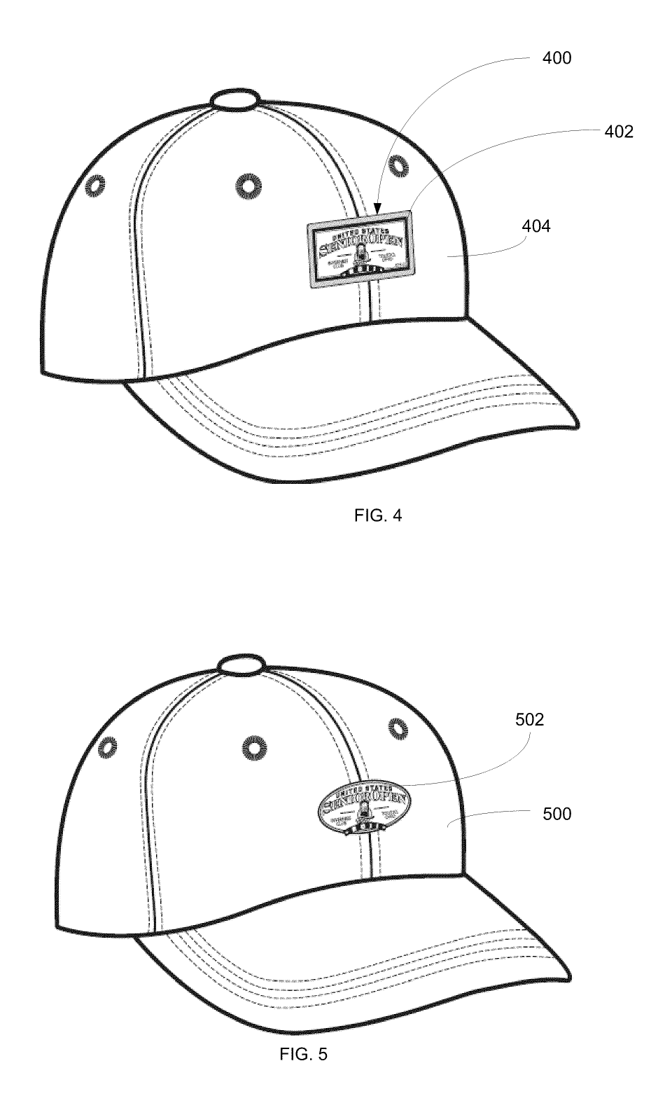

In addition to being stitched to a product, the appliqué can be heat fused to the product. FIG. 4 illustrates an example of an appliqué 400 having a substrate layer 402 that is heat fused to the surface of a product 404 (which in this example is a cap).

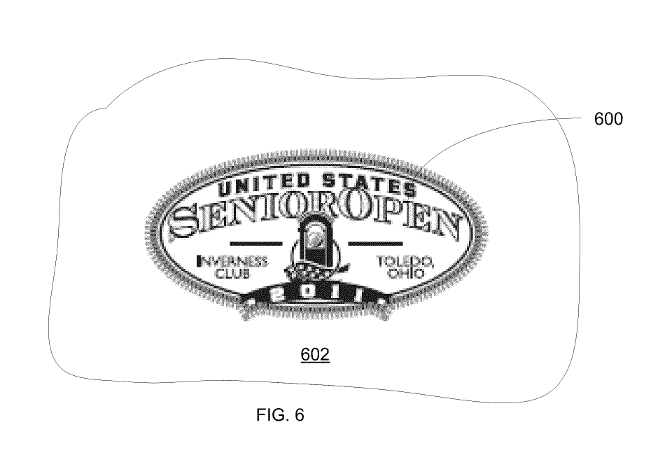

In accordance with one or more further embodiments, appliqués similar to those described above with respect to FIGS. 1-4 can be produced without a substrate layer. Appliqués without a substrate layer can be produced by digitally printing images on a sheet of material as described above with respect to FIG. 2B. The sheet of material on which the images are printed is then cut, preferably using a laser cutter or die cutter, to obtain multiple decorative pieces as described above with respect to the FIG. 2C. Instead of being applied to a substrate piece, the decorative pieces are then directly secured to the surface of a product such as, e.g., items of apparel, shoes, towels, and carrying items. A heat press can be used to securely fuse or bond the decorative piece on the product. FIG. 5 is an example of a product (in this example a cap) 500 on which an appliqué 502 with a substrate layer has been heat fused. Alternately, other techniques for securely attaching decorative pieces are also available including, e.g., use of spray/liquid adhesives and sheet/tape adhesives and stitching. FIG. 6 is an example of an appliqué 600 without a substrate layer that has been stitched to a surface 602 of a product.

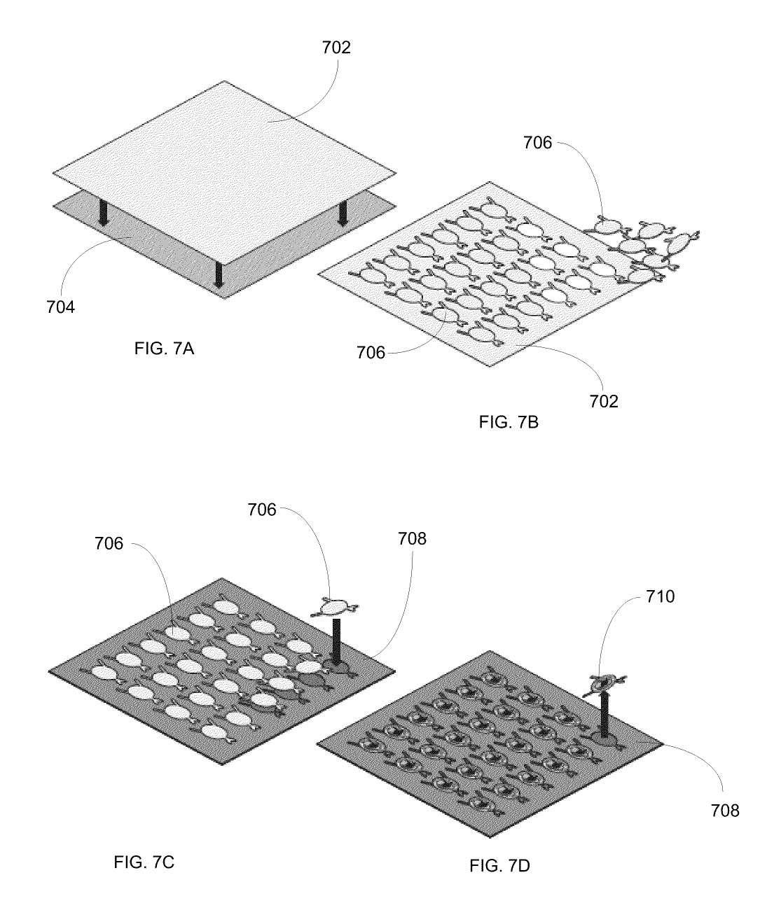

In accordance with one or more further embodiments, appliqués can be produced by first cutting “blank” appliqué pieces and then printing decorative images on the previously cut pieces. FIGS. 7A-7D illustrate an example of such a process.

FIG. 7A illustrates a sheet of material 702 similar to the sheet of material 202 shown in FIG. 2A. Design elements or images can be digitally printed on the upper surface of the sheet 702. An adhesive material 704 (like the adhesive material 202) is provided on the lower surface of the sheet of material 702.

As shown in FIG. 7B, multiple shaped pieces 706 are cut out of the sheet of material 702, preferably using a laser cutter or die cutter.

The pieces 706 are then placed into a “jig” or a template 708, which holds them in place during the printing process as shown in FIG. 7C. The jig 708 is mathematically aligned with the graphics software so that the printed image registers precisely with the small pieces 706.

Then, as shown in FIG. 7D, the pieces 706 are digitally printed. The printed pieces 710 can be heat cured to set the inks used in the printing process.

Thereafter, the printed pieces 710 can be applied to a substrate in a manner similar to that illustrated in FIGS. 2D-2G. The resulting appliqué with a substrate layer can then be applied to products in various ways including by being stitched or heat fused on products.

The printed pieces 710 can also be directly applied to products (without being attached to a substrate layer) in various ways including by being stitched or heat fused on products.

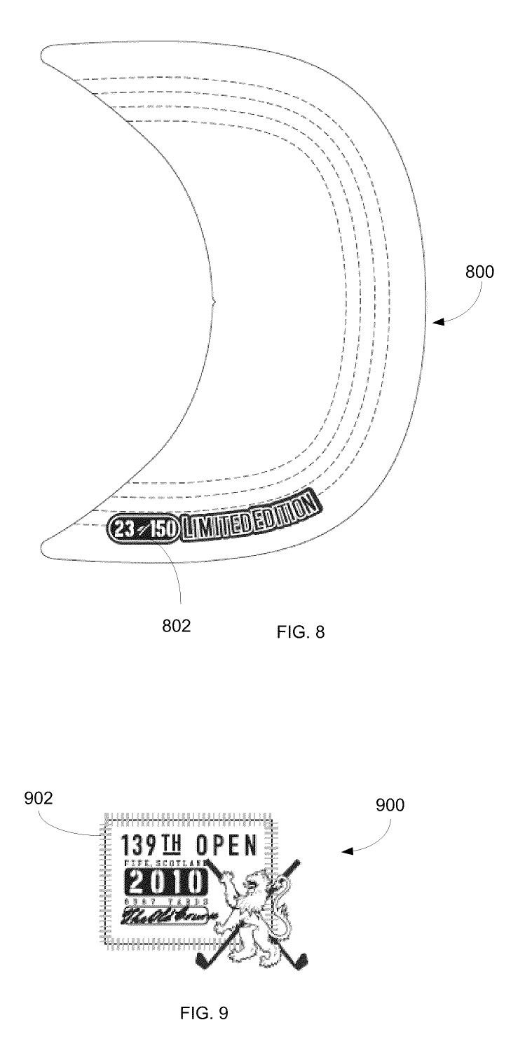

One advantage of an appliqué that is heat fused to a product is that it can be quickly and easily applied to a variety of products including, e.g., the bill of a finished hat or visor. FIG. 8 is an example of a visor bill 800 having an appliqué 802 heat fused on the upper surface of the bill 800. Stitching or embroidering an appliqué to a finished hat or visor bill is typically difficult because of the thickness of the bill. Appliqués can also be applied to other parts of hats or visors including, e.g., the sides, the front, or the back of hats or visors.

In accordance with one or more embodiments, a plurality of unique design elements can be digitally printed on appliqués to customize a set of products. For example, each appliqué can be printed to include one of a series of numbers in a collection. As shown in the visor example of FIG. 8, each appliqué can specify a particular number of a limited edition set. In other examples, appliqués with unique numbers or other identifiers can be applied on apparel for a sports team, where a unique number or name is provided for each player on the team. Using the digital printing techniques described herein, appliqués with such unique design elements can be quickly and easily manufactured.

A variety of design elements can be digitally printed on appliqués in accordance with one or more embodiments. The digital printing process allows designs and lettering of significantly higher resolution to be produced on appliqués than those that are woven or embroidered. In one or more embodiments, the design elements can be photographed images.

In accordance with one or more embodiments, the design elements digitally printed on appliqués include a printed stitch design at the periphery of the appliqué, providing the appearance of an embroidered border. FIG. 9 illustrates an example of an appliqué 900 having a printed stitch design 902.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Having described preferred embodiments of the present invention, it should be apparent that modifications can be made without departing from the spirit and scope of the invention.

What is claimed is:

1. A method of producing decorative articles and attaching the decorative articles to products, comprising the steps of:
digitally printing a plurality of design elements on an upper surface of a sheet of material;
cutting the sheet of material into a plurality of decorative pieces, each containing a design element on an upper surface thereof; and
securely attaching each of the decorative pieces to one of a plurality of products.

2. The method of claim 1 wherein cutting the sheet of material into a plurality of decorative pieces comprises laser cutting or die cutting the sheet of material around each of the printed design elements.

3. The method of claim 1 wherein attaching each of the decorative pieces to a product comprises providing a heat activated adhesive material on a lower surface of each of the decorative pieces and heat fusing the decorative pieces on the products.

4. The method of claim 1 wherein attaching each of the decorative pieces to a product comprises stitching each of the decorative pieces on a product.

5. The method of claim 1 wherein securely attaching each of the decorative pieces to a product comprises attaching a lower surface of each decorative piece to one side of a substrate layer, and attaching an opposite side of the substrate layer to the product, the substrate layer being shaped such that a peripheral portion of the substrate layer extends beyond the periphery of the decorative piece to define a border.

6. The method of claim 5 wherein attaching the substrate layer to the product comprises stitching the substrate layer to the product along the border.

7. The method of claim 5 wherein attaching the substrate layer to the product comprises heat fusing the opposite side of the substrate layer to the product.

8. The method of claim 1 wherein the sheet of material comprises a woven material or a non-woven material.

9. The method of claim 8 wherein the woven material comprises cotton twill, canvas, nylon, or faux-suede.

10. The method of claim 8 wherein the non-woven material comprises felt, leather, suede, molded or sheet rubber, molded or sheet plastic, pellon, scrim-felt, or faux-leather.

11. The method of claim 1 wherein the product comprises an item of apparel, a shoe, a towel, or a carrying item.

12. The method of claim 1 wherein each of the design elements is unique.

13. The method of claim 1 wherein each of the design elements includes one of a plurality of sequential numbers.

14. A method of producing decorative articles and attaching the decorative articles to products, comprising the steps of:
cutting a sheet of material into a plurality of pieces having predetermined shapes;
securing each of the pieces in a holder;
digitally printing a design element on an upper surface of each of the pieces; and
securely attaching a lower surface of each of the pieces to one of a plurality of products.

15. The method of claim 14 wherein cutting the sheet of material into a plurality of pieces comprises laser cutting or die cutting the sheet of material.

16. The method of claim 14 wherein securely attaching each of the pieces to a product comprises providing a heat activated adhesive material on a lower surface of each of the pieces and heat fusing the pieces on the products.

17. The method of claim 14 wherein attaching each of the pieces to a product comprises stitching each of the pieces on a product.

18. The method of claim 14 wherein securely attaching each of the pieces to a product comprises attaching a lower surface of each piece to one side of a substrate layer, and attaching an opposite side of the substrate layer to the product, the substrate layer being shaped such that a peripheral portion of the substrate layer extends beyond the periphery of the piece to define a border.

19. The method of claim 18 wherein attaching the substrate layer to the product comprises stitching the substrate layer to the product along the border.

20. The method of claim 18 wherein attaching the substrate layer to the product comprises heat fusing the opposite side of the substrate layer to the product.

21. The method of claim 14 wherein the sheet of material comprises a woven material or a non-woven material.

22. The method of claim 21 wherein the woven material comprises cotton twill, canvas, nylon, or faux-suede.

23. The method of claim 21 wherein the non-woven material comprises felt, leather, suede, molded or sheet rubber, molded or sheet plastic, pellon, scrim-felt, or faux-leather.

24. The method of claim 14 wherein the product comprises an item of apparel, a shoe, a towel, or a carrying item.

25. The method of claim 14 wherein each of the design elements is unique.

26. The method of claim 14 wherein each of the design elements includes one of a plurality of sequential numbers.

27. A product, comprising:
a product body having an outer surface; and
an appliqué attached to the outer surface of the product body, the appliqué comprising a decorative piece including an upper surface with a design element digitally printed thereon and an opposite lower surface attached to outer surface of the body.

28. The product of claim 27 wherein the appliqué further comprises a substrate piece, wherein the decorative piece is overlaid on the substrate piece, and a lower surface of the decorative piece is attached to the substrate piece, the decorative piece and the substrate piece being shaped such that a peripheral portion of the substrate piece extends beyond the periphery of the decorative piece to define a border for the appliqué.

29. The product of claim 28 wherein the substrate piece of the appliqué is positioned on and stitched to the outer surface of the product along the border.

30. The product of claim 28 wherein the substrate piece is heat fused to the outer surface of the product.

31. The product of claim 28 wherein the decorative piece is heat fused to the substrate piece.

32. The product of claim 28 wherein the substrate piece and the decorative piece include at least one opening extending therethrough for allowing a portion of the product to be visible through the at least one opening.

33. The product of claim 27 wherein the decorative piece comprises a woven material or a non-woven material.

34. The product of claim 33 wherein the woven material comprises cotton twill, canvas, nylon, or faux-suede.

35. The product of claim 33 wherein the non-woven material comprises felt, leather, suede, molded or sheet rubber, molded or sheet plastic, pellon, scrim-felt, or faux-leather.

36. The product of claim 27 wherein the product comprises an item of apparel, a shoe, a towel, or a carrying item.

37. The product of claim 27 wherein the product comprises a hat or visor having a bill portion, and wherein the appliqué is heat fused to the bill portion.

38. The product of claim 27 wherein the design element comprises a photographic image.

39. The product of claim 27 wherein the design element includes one of a plurality of sequential numbers.

40. The product of claim 27 wherein the design element includes a printed stitch design at the periphery of the appliqué, providing the appearance of an embroidered border.

41. A decorative article attachable to a product, the decorative article comprising:
a substrate piece; and
a decorative piece overlaid on the substrate piece, the decorative piece including an upper surface with a design element digitally printed thereon and an opposite lower surface attached to the substrate piece, the decorative piece and the substrate piece being shaped such that a peripheral portion of the substrate piece extends beyond the periphery of the decorative piece to define a border for the decorative article.

42. The decorative article of claim 41 wherein the substrate piece and the decorative piece each comprise a woven material or a non-woven material.

43. The decorative article of claim 42 wherein the woven material comprises cotton twill, canvas, nylon, or faux-suede.

44. The decorative article of claim 42 wherein the non-woven material comprises felt, leather, suede, molded or sheet rubber, molded or sheet plastic, pellon, scrim-felt, or faux-leather.

45. The decorative article of claim 41 wherein the product comprises an item of apparel.

46. The decorative article of claim 41 further comprising a heat activated adhesive material secured to the lower surface of the decorative piece for heat fusing the decorative piece to the substrate piece.

47. The decorative article of claim 41 wherein the substrate piece has multiple plies to increase the thickness thereof.

48. The decorative article of claim 41 wherein the decorative piece includes one or more openings extending therethrough and the substrate piece includes corresponding one or more opening extending therethrough to allow a portion of the product on which the decorative article is affixed to be visible through the openings.
